(19) United States
(12) Patent Application Publication
(10) Pub. No.: US 2003/0117375 A1
(43) Pub. Date: Jun. 26, 2003

(54) Character input apparatus

(75) Inventor: Haruhiko Suda, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/118,127

(22) Filed: Apr. 9, 2002

(30) Foreign Application Priority Data
Dec. 21, 2001 (JP) 2001-390070

(51) Int. Cl. G09G 5/00

(52) U.S. Cl. 345/169

(57) ABSTRACT

A combination of character codes assigned to a plurality of existing data entry keys is switched when necessary, which makes it possible to input symbols and characters including kana characters by intuitive manipulations on keys that are smaller in number than the kinds of characters to be input. Further, providing a data entry keypad on a cover for covering a part of a display screen makes it possible to realize both a function of inputting characters and a function of presenting documents by using a large display screen that is necessary in electronic book players and so on.

### BACKGROUND OF THE INVENTION

1. Field of the Invention

The present invention relates to a character input apparatus which enables input of characters and symbols in hand-held terminals including cellular phones, personal digital assistants (PDAs), and electronic book players.

A hand-held terminal can display a text on a display screen that is large for the size of the hand-held terminal. Therefore, the user can smoothly view a document such as a material captured from a personal computer or a mail during his movement. Such a document presenting function is considered very important particularly in electronic book players.

In many cases, hand-held terminals are used while a user is moving. There may frequently occur a case that the user manipulates a hand-held terminal while he is standing in a congested car of a train, for example. Therefore, it is desired to allow a user to perform manipulation with one hand for all functions including a character input function.

2. Description of the Related Art

Conventionally, PDAs have, in addition to the document presenting function, a character input function to enable generation of a simple memo or the like. In PDAs, the following two methods are mainly available as a method for character input.

The first method is one that utilizes hand-written character recognition. In a PDA having a hand-written character recognizing function, first, image data representing locus of the tip of a pen are captured by continuously detecting positions where the user causes the tip of the pen to be pressed against the display screen in writing a character by utilizing the function of a resistor-embedded membrane that is stuck to cover the display screen. The character represented by the image data is recognized by analyzing features of the image data. It can be said that the method utilizing the hand-written character recognizing function is a very intuitive one because the user inputs a character by drawing the intended character itself on the display screen.

The second method is one in which a part of the display screen is used as a keyboard, a tablet, or a digitizer. A PDA having this function is equipped, on the back side of the part of the display screen where the Japanese syllabary, the alphabet, or the like is displayed, with a plurality of antennas for detecting radio waves that are transmitted from a stylus pen. The position of a point on the display screen with which the tip of the stylus pen is in contact is determined based on detection results of the antennas, whereby a character corresponding to the determined position on the display screen is input. This type of input method using a digitizer is familiar to users who are accustomed to keyboard input or the like.

In each of the above two methods that are employed in conventional PDAs, a character is input by causing the tip of a stylus pen to contact the display screen. Therefore, it is necessary to hold the PDA with one hand and to grip the stylus pen and input characters with the other hand. It is substantially impossible for the user to input characters with one hand while standing during his movement.

A resistor-embedded membrane that is stuck to cover the display screen to enable continuous detection of pen-tip positions in PDAs that employ the hand-written character recognizing function, or a protection film that covers a liquid crystal panel to protect the liquid crystal in the liquid crystal panel from impact of the pen tip in PDAs that employ the input method utilizing a digitizer are factors of impairing the visibility of the liquid crystal screen.

Incidentally, cellular phones and PHS phones employ a method in which a character is input with one hand by pressing numeric keys for input of a telephone number according to a unique procedure. In Japan, this method is spread among young users.

For example, Japanese Unexamined Patent Application Publication No. 7-274247 discloses a technique where the rows of the Japanese syllabary are assigned to the respective numeric keys and one of the characters belonging to a row of the Japanese syllabary corresponding to a numeric key is input depending on the number of times the numeric key is pressed. Japanese Unexamined Patent Application Publication No. 2000-341761 discloses a technique in which a part of the numeric keys are assigned to alphabetical characters (i.e., A, I, U, E, and O) representing the vowels of the Japanese syllabary in the romanized transliteration and the other numeric keys are assigned to alphabetical characters (i.e., K, S, T, N, H, M, Y, R, and W) representing major consonants, whereby kana characters can be input by utilizing roman transliteration.

Each of the above techniques makes it possible to input, using a limited number of keys, characters that are more than the number of keys. By using one of these techniques, a text of a memo or a mail that is sufficiently practical can be input with one hand. Not requiring a stylus pen or the like, these techniques eliminate the above-described resistor-embedded membrane or protection film and can ensure sufficiently high visibility when applied to electronic players etc.

However, it cannot be said that the techniques disclosed in Japanese Unexamined Patent Application Publication Nos. 7-274247 and 2000-341761 are necessarily suitable for everybody and easy to understand, because a user needs to manipulate the numeric keys according to artificial rules that are never used in everyday life.

### SUMMARY OF THE INVENTION

An object of the present invention is to provide a character input apparatus capable of inputting kana characters or other characters such as alphabetical characters by intuitive manipulations on keys that are smaller in number than the kinds of characters to be input.

Another object of the invention is to provide a character input apparatus which allows the user to intuitively recognize how to manipulate inputting a desired character.

Another object of the invention is to provide a character input apparatus which does not require a pen or like means for character input.

An object of the present invention is to provide a character input apparatus which allows a hand-held terminal to maintain a good condition on the display, which is a condition inherent to the capability of the display unit of the hand-held terminal.

Still another object of the invention is to provide a character input apparatus capable of realizing both of a character input function and a document presenting function using a large display screen that is necessary in electronic book players etc.

Yet another object of the invention is to provide, for a character input apparatus, a technique for assisting the user in performing a manipulation of inputting a desired character.

A further object of the invention is to provide a character input apparatus with a user interface that is very easy to understand.

According to one of the aspects of the present invention, the invention provides a first character input apparatus including an input unit having a data entry keypad having a predetermined number of data entry keys; a code assignment table storing codes indicating characters that are assigned to the data entry keys, respectively; a read unit for reading, in response to each manipulation on each of the data entry keys, a code corresponding to the manipulated data entry key from the code assignment table unit; an assignment switching unit for switching the contents of the code assignment table in response to a switching instruction; and an instruction inputting unit for inputting a proper switching instruction to the assignment switching unit when a predetermined manipulation is detected.

This character input apparatus makes it possible to input all kana characters by combinations of manipulations of generating switching instructions and manipulations of pressing data entry keys, with a small number of (e.g., 15) data entry keys.

According to another aspect of the present invention, the invention also provides a second character input apparatus provided in a hand-held terminal having a display unit with a cover for covering a part of the display unit, the character input apparatus including an input unit having a data entry keypad including a predetermined number of data entry keys; a code assignment table storing codes indicating characters that are assigned to the data entry keys, respectively; a read unit for reading, in response to each manipulation on each of the data entry keys, a code corresponding to the manipulated data entry key from the code assignment table; an assignment switching unit for switching the contents of the code assignment table in response to a switching instruction; and an instruction inputting unit for inputting a proper switching instruction to the assignment switching unit when a predetermined manipulation is detected, in which the data entry key pad that is provided on a surface of the cover that does not face the display unit when a part of the display unit is covered with the cover. The input unit also includes: a manipulation detecting unit for detecting a manipulation of placing the cover on the display unit; and an input controlling unit for inputting, to the read unit, information indicating each manipulation on each of the data entry keys of the data entry keypad, in which the inputting is done according to a result of the detection by the manipulation detecting unit.

In this character input apparatus, a manipulation of placing the cover on the display unit can be used as a switch for enabling some functions of the character input apparatus. Further, a sufficient character input capability can be obtained while the size of the display area of the display unit of the hand-held terminal is maintained.

According to still another aspect of the present invention, the first or second character input apparatus may further include an assignment displaying unit for displaying information indicating a combination of the codes stored in the code assignment table.

This character input apparatus allows the user to easily recognize characters that are assigned to the respective data entry keys.

According to another aspect of the present invention, the assignment displaying unit may include key-top displaying units each provided on each top of the data entry keys on the input unit, for displaying characters corresponding to codes inputted, respectively; and a code inputting unit for inputting the codes stored in the code assignment table to the respective key-top displaying units.

In this character input apparatus, characters that are currently assigned to the respective data entry keys can be displayed by the respective key-top displaying units.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing the principle of a first character input apparatus according to the present invention;

FIG. 2 is a block diagram showing the principle of a second character input apparatus according to the invention;

FIG. 3 is a block diagram showing a character input apparatus according to an embodiment of the invention;

FIGS. 4A and 4B show an exemplary appearance of a hand-held terminal that is equipped with the character input apparatus shown in FIG. 3;

FIGS. 5A and 5B are charts illustrating the operation of the character input apparatus shown in FIG. 3;

FIG. 6 is a flowchart showing the operation of the character input apparatus shown in FIG. 3; and

FIGS. 7A and 7B show a specific example of character input using the Japanese syllabary.

### DESCRIPTION OF THE PREFERRED EMBODIMENT

Principles

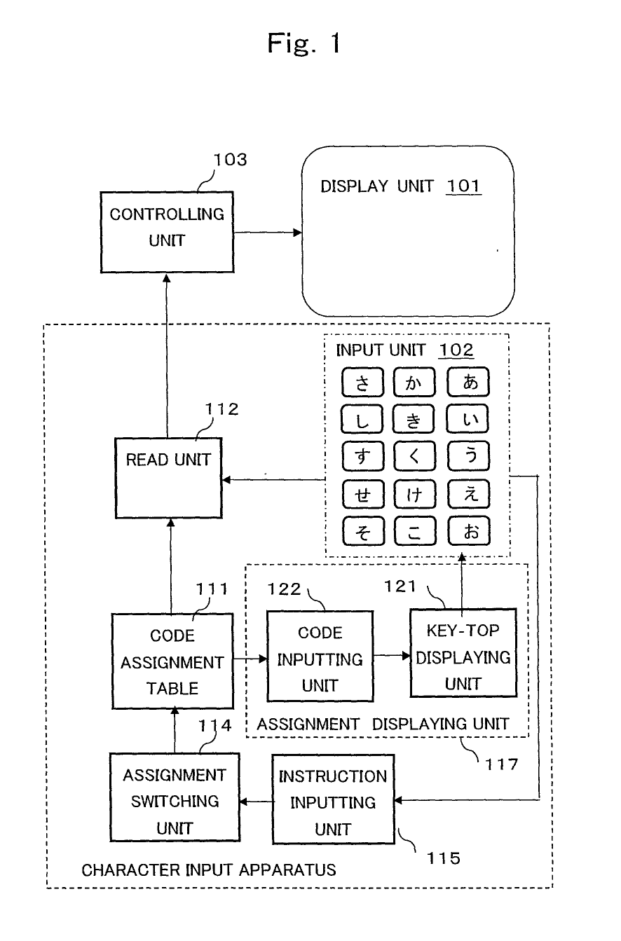

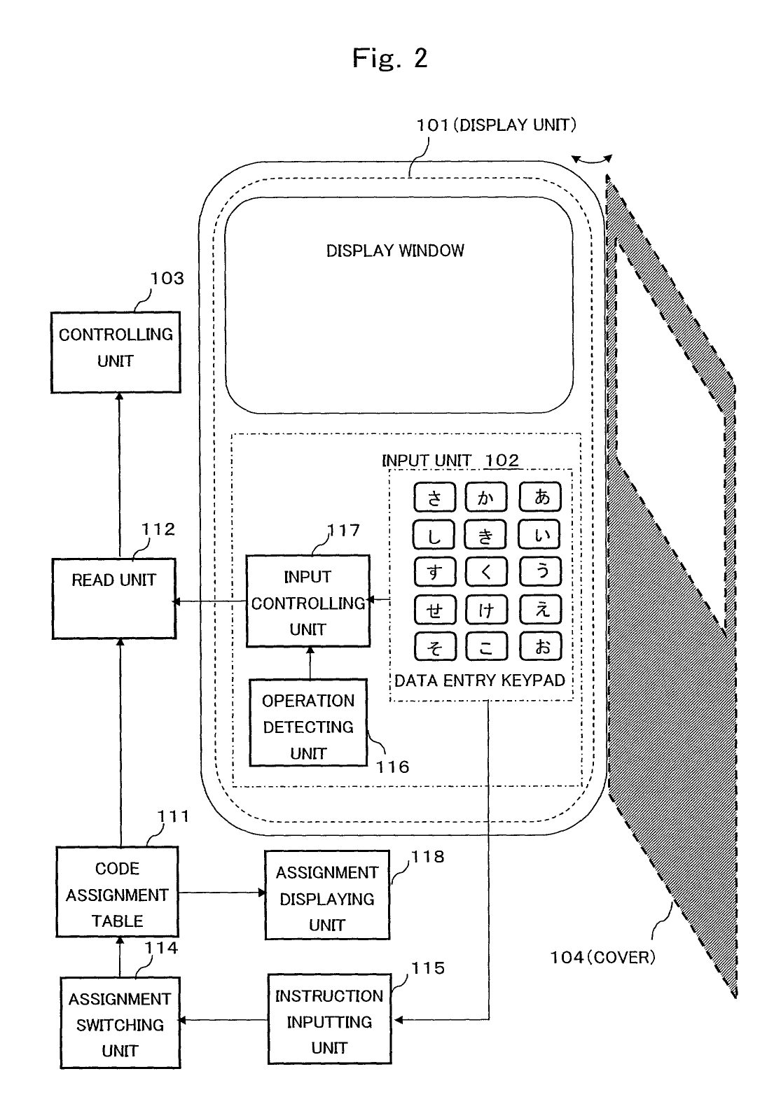

First, the principles of character input apparatuses according to the present invention will be described with reference to FIGS. 1 and 2.

FIG. 1 is a block diagram showing the principle of a first character input apparatus according to the invention.

The first character input apparatus shown in FIG. 1 is composed of an input unit 102, a code assignment table 111, a read unit 112, an assignment switching unit 114, and an instruction inputting unit 115.

The principle of the first character input apparatus according to the invention is as follows.

The first character input apparatus is provided in a hand-held terminal having a display unit 101 and inputs information indicating a character to the controlling unit 103 for controlling operation of the hand-held terminal. The input unit 102 has a data entry keypad including a predetermined number of data entry keys. The code assignment table 111 stores codes indicating characters that are assigned to the data entry keys, respectively. The read unit 112 reads, in response to pressing each data entry key, a code corresponding to the pressed data entry key from the code assignment table 111, and inputs the code read to the controlling unit 103. The assignment switching unit 114 switches, in response to a switching instruction, the contents of the code assignment table 111 to a combination of codes specified by the switching instruction. The instruction inputting unit 115 detects when the data entry keys or other function keys provided in the hand-held terminal is manipulated according to a predetermined procedure, and inputs a proper switching instruction to the assignment switching unit 114 in accordance with the result of the detection.

The first character input apparatus having the above configuration operates in the following manner.

The assignment switching unit 114 switches, in response to a switching instruction supplied from the instruction inputting unit 115, the contents of the code assignment table 111 to a proper combination of codes, whereby the set of characters assigned to the set of data entry keys of the hand-held terminal can be switched set by set. Therefore, in a state that a set of characters including a desired character is stored in the code assignment table 111, the read unit 112 reads a code indicating the desired character from the code assignment table 111 in response to pressing the corresponding data entry key.

FIG. 2 is a block diagram showing the principle of a second character input apparatus according to the invention.

The second character input apparatus shown in FIG. 2 is composed of an input unit 102, a code assignment table 111, a read unit 112, an assignment switching unit 114, an instruction inputting unit 115, a manipulation detecting unit 116, and an input controlling unit 117.

The principle of the second character input apparatus according to the invention is as follows.

The second character input apparatus is provided in a hand-held terminal having a display unit 101 with a cover 104 for covering a part of the display unit 101, and inputs information indicating a character to the controlling unit 103 for controlling operation of the hand-held terminal. The input unit 102 has a data entry keypad including a predetermined number of data entry keys. The code assignment table 111 stores codes indicating characters that are assigned to the data entry keys, respectively. The read unit 112 reads, in response to pressing each data entry key, a code corresponding to the pressed data entry key from the code assignment table 111, and inputs the code read to the controlling unit 103. The assignment switching unit 114 switches, in response to a switching instruction, the contents of the code assignment table 111 to a combination of codes specified by the switching instruction. The instruction inputting unit 115 detects when the data entry keys or other function keys provided in the hand-held terminal is manipulated according to a predetermined procedure, and inputs a proper switching instruction to the assignment switching unit 114 in accordance with the result of the detection.

The data entry key pad is provided on the surface of the cover 104 that does not face the display unit 101 when a part of the display unit 101 is covered with the cover 104. In the input unit 102, the manipulation detecting unit 116 detects the manipulation of placing the cover 104 on the display unit 101. Also in the input unit 102, the input controlling unit 117 inputs, to the read unit 112, information indicating that one of the data entry keys of the data entry keypad is pressed while the result of the detection by the manipulation detecting unit 116 indicates that the cover 104 is placed on the display unit 101.

The second character input apparatus having the above configuration operates in the following manner.

While the cover 104 is placed on the display unit 101, the input controlling unit 117 inputs information to the read unit 112 each time a data entry key is pressed, according to a detection result of the manipulation detecting unit 116.

A third character input apparatus according to the invention is composed of the components of the first or second character input apparatus and an assignment displaying unit 118.

The principle of the third character input apparatus is as follows.

In the first or second character input apparatus, the assignment displaying unit 118 displays information indicating a combination of the codes stored in the code assignment table 111.

The third character input apparatus having the above configuration operates in the following manner.

The assignment displaying unit 118 displays information indicating a set of the codes stored in the code assignment table 111 and thereby presents it to the user.

The principle of the fourth character input apparatus according to the invention is as follows.

In the first or second character input apparatus, a plurality of key-top displaying units 121 are each provided on each top of the data entry keys on the input unit 102, and display characters corresponding to codes inputted, respectively. A code inputting unit 122 inputs the codes stored in the code assignment table 111 to the respective key-top displaying units 121.

The fourth character input apparatus having the above configuration operates in the following manner.

The code inputting unit 122 inputs the codes stored in the code assignment table 111 to the respective key-top displaying units 121, and the key-top displaying units 121 display respective proper characters according to the received code.

Embodiment

An embodiment of the present invention will be hereinafter described in detail with reference to the drawings.

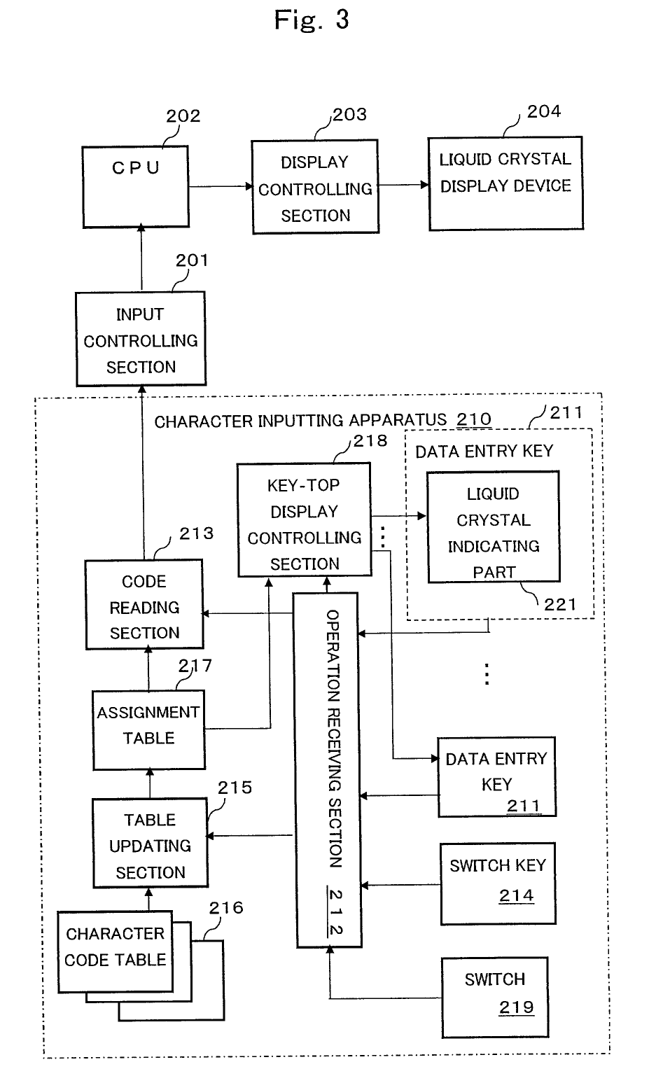

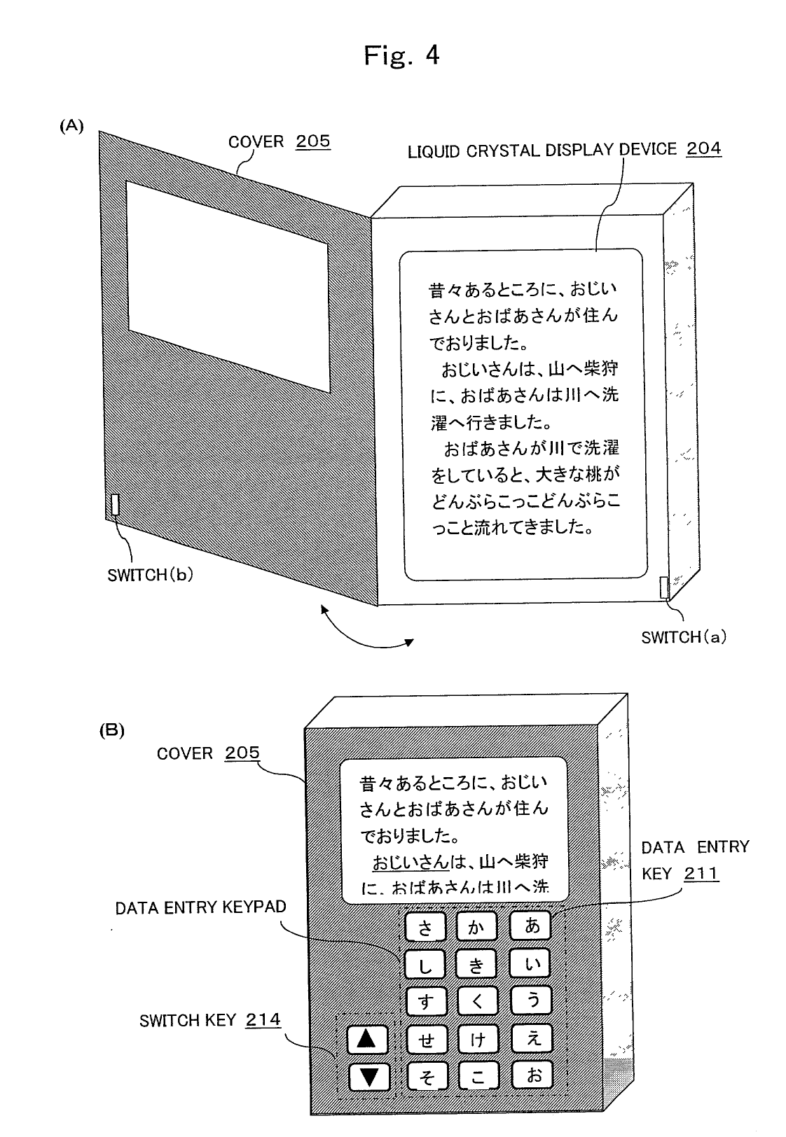

FIG. 3 shows a character input apparatus 210 according to an embodiment of the invention. FIGS. 4A and 4B show an exemplary appearance of a hand-held terminal that is equipped with the character input apparatus 210 shown in FIG. 3.

In a hand-held terminal shown in FIG. 3, data indicating characters that have been input through the character input apparatus 210 are transmitted to a CPU 202 via an input controlling section 201. The data are subjected to data processing by the CPU 202, and are transmitted to a display controlling section 203 and displayed on a liquid crystal display device 204 by the functions of the display controlling section 203.

In the character input apparatus 210 shown in FIG. 3, each of n data entry keys 211 has a liquid crystal indicating part 221 having a display region that is within the area of the key-top of each data entry key 211. A signal that is generated upon pressing each data entry key 211 is input to a code reading section 213 via a manipulation receiving section 212. A signal that is generated upon pressing a switch key 214 is input to a table updating section 215 and a key-top display controlling section 218 via the manipulation receiving section 212.

In the character input apparatus 210, a character code table 216 holds a plural sets (combinations; hereinafter referred to as “code sets”) of character codes to be assigned to the n data entry keys 211. The table updating section 215 selectively reads one code set from the character code table 216 in accordance with a signal received from the manipulation receiving section 212, and writes the selected code set to an assignment table 217.

The code reading section 213 shown in FIG. 3 selectively reads one of character codes stored in the assignment table 217 in accordance with a signal received from the manipulation receiving section 212, and supplies the selected character code to the CPU 202 via the input controlling section 201 that is provided in the hand-held terminal so that the character code will be processed by the CPU 202.

The key-top display controlling section 218 shown in FIG. 3 reads the code set stored in the assignment table 217 every time it receives, from the manipulation receiving section 212, a signal that has been generated upon pressing the switch key 214, and controls display of each of the liquid crystal indicating parts 221 provided in the respective data entry keys 211.

As shown in FIG. 4A, a switch 219 shown in FIG. 3 may be composed of a switch member a that is provided in the main body of the hand-held terminal and a switch member b that is provided in a cover 205. When the switch members a and b come into contact with each other by a manipulation of placing the cover 205 on the main body of the hand-held terminal, a signal enabling reception is supplied from the switch 219 to the manipulation receiving section 212.

The cover 205 shown in FIGS. 4A and 4B is formed with an opening. When the cover 205 is placed on the main body of the hand-held terminal, the opening serves as a display window, and a part of the display screen of the liquid crystal display device 204 that can be seen through the opening is provided to the users (see FIG. 4B).

A data entry keypad shown in FIG. 4B, which is formed by the n data entry keys 211 shown in FIG. 3, is provided on the front side of the cover 205, that is, on the side of the cover 205 that does not face the liquid crystal display 204 when the cover 205 is placed on the main body of the hand-held terminal. FIG. 4B shows an example in which the data entry keypad is formed by 15 data entry keys 211 and the switch key 214 is formed by two keys having an upward triangle and a downward triangle in FIG. 4B (hereinafter referred to as “backward key” and “forward key,” respectively).

A corresponding relationship between the units shown in FIGS. 1 and 2 and the sections shown in FIG. 3 and FIGS. 4A and 4B will be described below.

The input controlling section 201, CPU 202 and the display controlling section 203 shown in FIG. 3 correspond to the controlling unit 103 shown in FIG. 1. The liquid crystal display device 204 shown in FIG. 3 corresponds to the display unit 101 shown in FIG. 1. The n data entry keys 211 shown in FIG. 3 correspond to the respective data entry keys constituting the data entry keypad shown in FIG. 1. The assignment table 217 shown in FIG. 3 corresponds to the code assignment table 111 shown in FIG. 1. The code reading section 213 shown in FIG. 3 corresponds to the read unit 112 shown in FIG. 1. The function of the assignment switching unit 114 shown in FIG. 1. is attained by the table updating section 215 and the character code table 216 shown in FIG. 3. The function of the key-top displaying units 121 shown in FIG. 1 is attained by the liquid crystal indicating parts 221 that are provided in the n respective data entry keys 211 shown in FIG. 3. The function of the code inputting unit 122 shown in FIG. 1 is attained by the key-top display controlling section 218 and the manipulation receiving section 212 shown in FIG. 3. The switch 219 shown in FIG. 3 corresponds to the manipulation detecting unit 116 shown in FIG. 2. The manipulation receiving section 212 shown in FIG. 3 corresponds to the input controlling unit 117 shown in FIG. 2.

Next, the operation of the character input apparatus 210 according to the embodiment will be described.

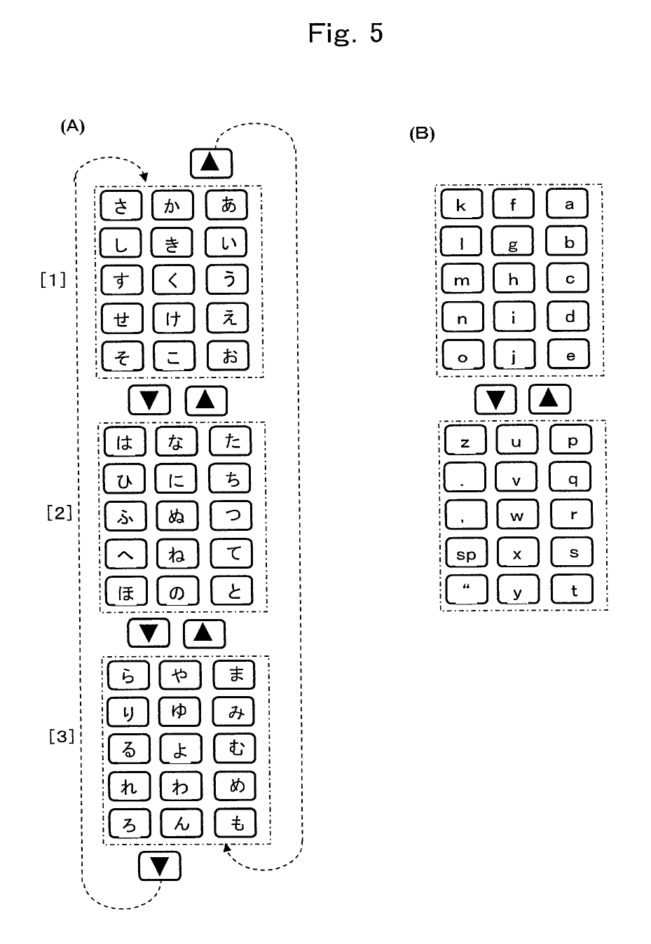

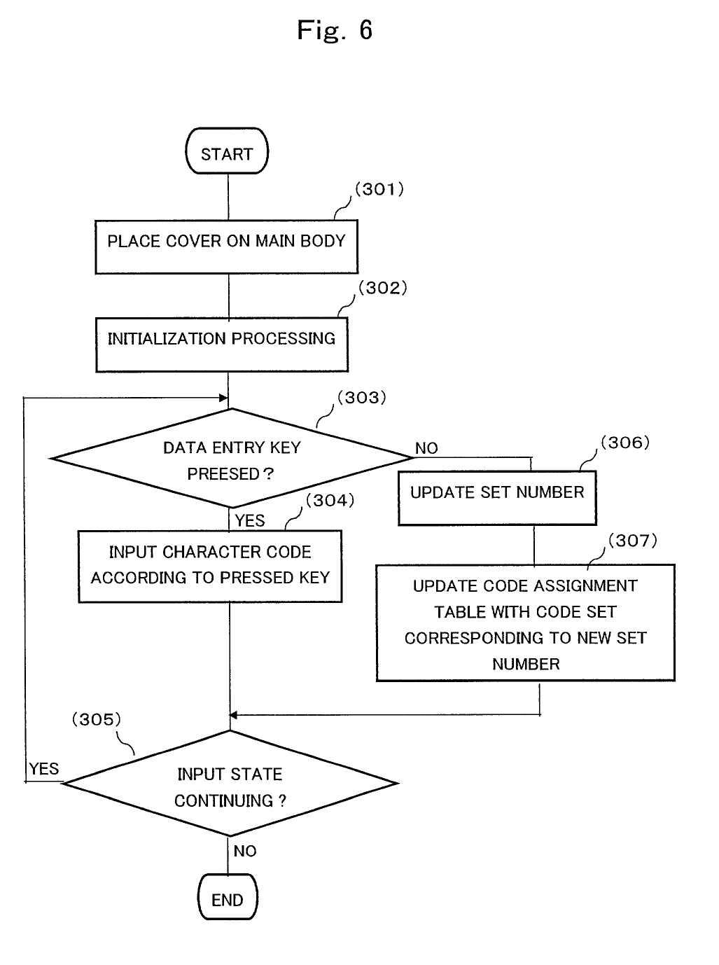

FIGS. 5A and 5B are charts illustrating the operation of the character input apparatus 210 according to the embodiment. FIG. 6 is a flowchart showing the operation of the character input apparatus 210.

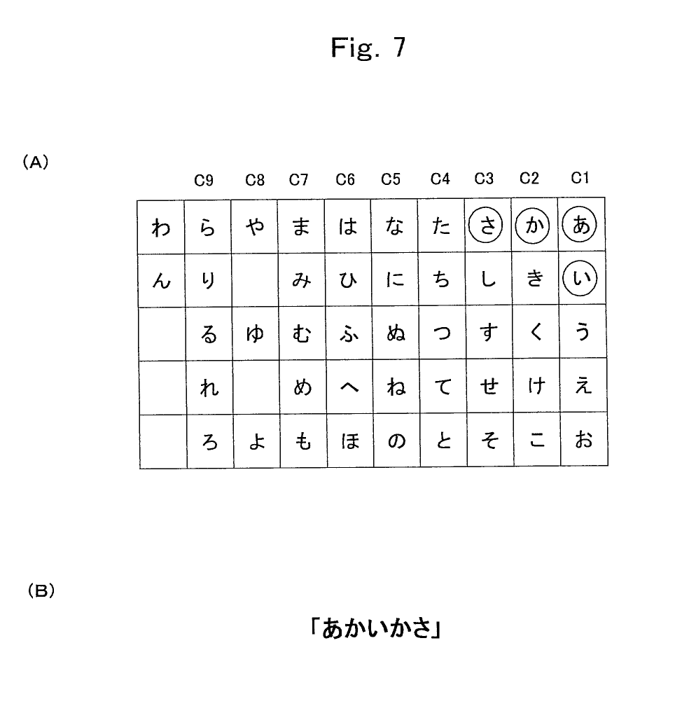

The operation of the character input apparatus 210 will be described by following the flowchart of FIG. 6 with reference to FIGS. 3, 4A, and 4B, for a case when ajapanese text is input using the three code sets shown in FIG. 5A which are switched among each other. FIGS. 7A and 7B show a specific example of character input using the Japanese syllabary.

A first code set that consists of character codes corresponding to the characters belonging to first three columns C1-C3 in the Japanese syllabary shown in FIG. 7A, a second code set that consists of character codes corresponding to the characters belonging to second three columns C4-C6, and a third code set that consists of character codes corresponding to the characters belonging to third three columns C7-C9 and the characters belonging to the last column are prepared in the character code table 216.

First, when the cover 205 is placed on the main body of the hand-held terminal as shown in FIG. 4B, a signal to the effect that the character input function has been made effective is supplied from the switch 219 to the manipulation receiving section 212 (step 301).

In response to this signal, the manipulation receiving section 212 shown in FIG. 3 issues, to the table updating section 215, an instruction to, for example, initialize the contents of the assignment table 217. In response to this instruction, the table updating section 215 reads the first code set, for example, from the character code table 216 and stores it in the assignment table 217 (step 302). At this time, the table updating section 215 holds a set number “1” indicating the first code set as information indicating the code set stored in the assignment table 217.

As a result of the above initialization processing, immediately after the closing of the cover 205, the characters belonging to the first three columns C1-C3 in the Japanese syllabary shown in FIG. 7A are displayed by the liquid crystal indicating parts 221 provided in the respective data entry keys 211 in a manner indicated by symbol [1] in FIG. 5A. Then, the character input apparatus 210 is rendered in an input waiting state.

The input waiting state is canceled upon manipulation of the switch key 214 or a data entry key 211 of the data entry keypad. At step 303, the manipulation receiving section 212 judges whether the manipulated key is a data entry key 211.

If the manipulated key is one of the data entry keys 211 (an affirmative judgement at step 303), the manipulation receiving section 212 transmits information indicating the manipulated data entry key 211 to the code reading section 213. In response, the code reading section 213 reads a character code that is stored in the assignment table 217 as one corresponding to the manipulated data entry key 211 and inputs it to the main body of the hand-held terminal via the input controlling section 201 shown in FIG. 3 (step 304).

Consideration will be given to a case of inputting a character string consisting of five characters all of which belong to the first three columns C1-C3 in the Japanese syllabary shown in FIG. 7A. The characters constituting the character string shown in FIG. 7B are circled in FIG. 7A.

In a state that the characters belonging to the first three columns C1-C3 are displayed on the key-tops of the respective data entry keys 211 as indicated by symbol [1] in FIG. 5A, the user can easily find data entry keys on the key-tops of which the characters constituting the character string are displayed. The user can easily input the intended kana characters by pressing the thus-found data entry keys in order once for each key.

Then, the manipulation receiving section 212 judges, based on a signal supplied form the switch 219, whether the input state is continuing (step 305) If the judgment result is affirmative, the process returns to step 303 and input by the user is waited for.

On the other hand, if one of the two keys of the switch key 214 shown in FIG. 4B has been manipulated, a negative judgment is made at step 303. In this case, the manipulation receiving section 212 transmits information indicating the manipulated key to the table updating section 215. In response, the table updating section 215 updates the set number (step 306) and updates the contents of the assignment table 217 in accordance with the new set number (step 307). Then, the process goes to step 305.

For example, if the forward key shown in FIG. 4B has been manipulated in the state that the first code set is stored in the assignment table 217 as indicated by symbol [1] in FIG. 5A, the table updating section 215 updates, that is, increments, the set number in accordance with information supplied from the manipulation receiving section 212 (step 306). Then, the table updating section 215 reads the second code set corresponding to the new set number from the character code table 216 and updates the contents of the assignment table 217 to the second code set (step 307).

As a result of the above assignment switching processing, the character codes that are input to the liquid crystal indicating parts 221 of the respective data entry keys 211 from the key-top display controlling section 218 shown in FIG. 3 are switched to the character codes belonging to the second code set. Therefore, from this time onward, the characters belonging to the three columns C4-C6 in the Japanese syllabary shown in FIG. 7A are displayed on the key-tops of the respective data entry keys 211 as indicated by symbol [2] in FIG. 5A. Any of these characters can be input by one key manipulation.

Conversely, if the table updating section 215 is informed by the manipulation receiving section 212 that the backward key shown in FIG. 4B has been manipulated, the table updating section 215 updates, that is, decrements, the set number (step 306) and the new set number is used at step 307. If the set number can have numerical values “1” to “3” cyclically in the table updating section 215, the code set that is assigned to the data entry keypad can be switched, by one manipulation, from the first code set to the third code set (indicated by symbol [3] in FIG. 5A) or, conversely, from the third set to the first set as indicated by broken lines in FIG. 5A.

By switching, in the above-described manner, the code set that is assigned to the data entry keypad, individual characters belonging to the Japanese syllabary can be input by using the small number of data entry keys by a small number of manipulations.

The characters belonging to each code set are arranged in the code set in the same order as in the Japanese Syllabary, and switching between code sets is performed according to their arrangement order in the Japanese syllabary. Therefore, whichever code set is assigned to the data entry keypad, the user can easily find a data entry key to which a desired character is assigned. When a desired character is not included in a currently assigned code set, the user can easily perform a manipulation for switching to a code set including the desired character.

Further, by additionally preparing, in the character code table 216, a code set consisting of character codes indicating small characters and characters representing voiced consonants and semi-voiced consonants, all characters appearing in Japanese documents can be input by using the character input apparatus 210. Naturally, another configuration is possible in which other function keys are provided separately from the data entry keypad shown in FIG. 4A and a function of adding a voiced sound mark or a semi-voiced sound mark to the immediately preceding or following character and a function of converting the immediately preceding or following character into a small character are assigned to these function keys.

By preparing, in the character code table 216, a code set consisting of frequently used symbols such as punctuation marks and parentheses, the character input function becomes sufficient for documents to be generated by the hand-held terminal.

Because characters are assigned to the data entry keys 211 according to the character arrangement of the Japanese syllabary, the way to manipulate the character input apparatus 210 is easy to understand for users of a very wide range. This is because users who handle Japanese are very familiar with the character arrangement of the Japanese syllabary and hence need not remember a new notation for character input.

It is apparent that this feature is very important in seeking a new class of users, such as elders and children, who have not used the conventional hand-held terminals. This is because kana characters and alphabetical characters are specially arranged on character input apparatuses on keyboards attached to general personal computers and word processors, and a method for inputting using roman transliteration that is widely employed in character input apparatuses are high barriers that separate persons who are not familiar with the arrangements and the method.

Another configuration is possible in which a code set a consisting of character codes indicating alphabetical characters “a” to “o” and a code set b consisting of character codes indicating alphabetical characters “p” to “z” and symbols such as the period are prepared in the character code table 216 and switching is made between the code sets a and b in response to a manipulation on the switching key 214 in the above-described manner (see FIG. 5B).

By preparing, in this manner, the code sets in which character codes are arranged in alphabetical order, even users who are not familiar with the key arrangement of typewriters can easily find desired characters and input those.

The liquid crystal indicating parts 221 provided in the respective data entry keys 211 and the key-top display controlling section 218 operate to display, on the key-tops of the respective data entry keys 211, characters that are currently assigned to the respective data entry keys 211. This is a user interface which is very easy to understand.

The second best method for realizing the assignment displaying unit 118 is such that a plurality of characters one of which is assigned to the associated data entry key 211 when the corresponding code set is assigned to the data entry keypad are printed on the key-top or the neighborhood of the associated data entry key 211, and that, for example, a set number indicating a currently assigned code set is displayed by a certain method.

Since the data entry keypad and the switch key 214 are arranged on the cover 205 having the opening as shown in FIGS. 4A and 4B, a part of the information displayed on the liquid crystal display device 204 and the data entry keypad can be presented to the user at the same time when the cover 205 is placed on the liquid crystal display device 204 of the hand-held terminal. With this configuration, the user can input characters without touching the liquid crystal display, by manipulating the data entry keypad and the switch key 214 that are arranged on the cover 205. Therefore, naturally, it is not necessary to use a protection film for covering the display screen or a resistor-embedded membrane. Therefore, the liquid crystal display device 204 can sufficiently exercise its inherent display capability. When the character input function is not used, the entire display screen of the liquid crystal display device 204 appears by opening the cover 205. This makes it possible to ensure a sufficiently large display area when the hand-held terminal is used as a document display apparatus.

Further, the character input apparatus according to the invention allows the user to input characters easily with one hand that holds the hand-held terminal irrespective of whether to employ the structure that the data entry keypad is provided on the cover 205. This is because, first, no pen for character input is necessary. Second, since the number of data entry keys 211 constituting the data entry keypad can be reduced, the data entry keys 211 and the switch key 214 can surely be arranged in such a range as to be manipulated well by the thumb, for example, of the hand that holds the hand-held terminal. Therefore, a user who is standing as he is moving in a train or the like can input characters very smoothly using a hand-held terminal having applied the character input apparatus according to the invention.

The invention is not limited to the above embodiments and various modifications may be made without departing from the spirit and scope of the invention. Any improvement may be made in part or all of the components.

What is claimed is:

1. A character input apparatus which is provided in a hand-held terminal having a display unit and which inputs information indicating a character to a controlling unit for controlling operation of the hand-held terminal, the character input apparatus comprising:
an input unit having a data entry keypad including a predetermined number of data entry keys;
a code assignment table storing codes indicating characters that are assigned to the data entry keys, respectively;
a read unit for reading, in response to each manipulation on each of the data entry keys, a code corresponding to the manipulated data entry key from the code assignment table, and for inputting the code read to the controlling unit;
an assignment switching unit for switching, in response to a switching instruction, contents of the code assignment table to a combination of codes specified by the switching instruction; and
an instruction inputting unit for detecting when the data entry keys or other function keys provided in the hand-held terminal is manipulated according to a predetermined procedure, and for inputting a proper switching instruction to the assignment switching unit in accordance with a result of the detection.

2. A character input apparatus which is provided in a hand-held terminal having a display unit with a cover for covering a part of the display unit and which inputs information indicating a character to a controlling unit for controlling operation of the hand-held terminal, the character input apparatus comprising:
an input unit having a data entry keypad including a predetermined number of data entry keys;
a code assignment table storing codes indicating characters that are assigned to the data entry keys, respectively;
a read unit for reading, in response to each manipulation on each of the data entry keys, a code corresponding to the manipulated data entry key from the code assignment table, and for inputting the code read to the controlling unit;
an assignment switching unit for switching, in response to a switching instruction, contents of the code assignment table to a combination of codes specified by the switching instruction; and
an instruction inputting unit for detecting when the data entry keys or other function keys provided in the hand-held terminal is manipulated according to a predetermined procedure, and for inputting a proper switching instruction to the assignment switching unit in accordance with a result of the detection, wherein:
said data entry key pad is provided on a surface of a cover that does not face the display unit when a part of the display unit is covered with the cover; and
said input unit includes
a manipulation detecting unit for detecting a manipulation of placing the cover on the display unit and
an input controlling unit for inputting, to the read unit, information indicating each manipulation on each of the data entry keys of the data entry keypad while a result of the detection by the manipulation detecting unit indicates that the cover is placed on the display unit.

3. The character input apparatus according to claim 1, further comprising an assignment displaying unit for displaying information indicating a combination of the codes stored in the code assignment table.

4. The character input apparatus according to claim 2, further comprising an assignment displaying unit for displaying information indicating a combination of the codes stored in the code assignment table.

5. The character input apparatus according to claim 1, further comprising:
a plurality of key-top displaying units provided on tops of the data entry keys on the input unit, for displaying characters corresponding to input codes, respectively; and
a code inputting unit for inputting the codes stored in the code assignment table to the respective key-top displaying units.

6. The character input apparatus according to claim 2, further comprising:
a plurality of key-top displaying units provided on tops of the data entry keys on the input unit, for displaying characters corresponding to input codes, respectively; and
a code inputting unit for inputting the codes stored in the code assignment table to the respective key-top displaying units.
